(19) United States
(12) Patent Application Publication
(10) Pub. No.: US 2026/0231180 A1
(43) Pub. Date: Aug. 6, 2026

(54) METHODS AND APPARATUSES FOR TRANSMITTING SIDELINK POSITIONING REFERENCE SIGNAL

(71) Applicant: Lenovo (Beijing) Limited, Beijing (CN)

(72) Inventors: Xiaodong Yu, Beijing (CN); Zhennian Sun, Beijing (CN); Haipeng Lei, Beijing (CN); Xin Guo, Beijing (CN); Yu Zhang, Beijing (CN)

(73) Assignee: Lenovo (Beijing) Limited, Beijing (CN)

(21) Appl. No.: 18/876,849

(22) PCT Filed: Jun. 27, 2022
(86) PCT No.: PCT/CN2022/101531

§ 371 Date: Dec. 19, 2024

(51) Int. Cl. H04W 72/25; H04W 64/00; H04W 72/044

(52) U.S. Cl. CPC H04W 72/25; H04W 64/00; H04W 72/044

(57) ABSTRACT

The present application relates to methods and apparatuses for transmitting a sidelink (SL) positioning reference signal (PRS). One embodiment of the present disclosure provides a user equipment (UE), which includes: a transceiver; and a processor coupled with the transceiver and configured to: obtain configuration information associated with a set of pairs of regions in time and frequency domains, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and determine a sidelink slot structure based on the configuration information.

### TECHNICAL FIELD

The present disclosure relates to wireless communication technology, and more particularly, related to methods and apparatuses for transmitting a sidelink (SL) positioning reference signal (PRS) in 3rd Generation Partnership Project (3GPP) 5G and/or NR (new radio) networks.

### BACKGROUND OF THE INVENTION

Vehicle to everything (V2X) has been introduced into 3GPP 5G wireless communication technology. In terms of a channel structure of V2X communication, a direct link between two UEs is called a sidelink. A sidelink is a long-term evolution (LTE) feature introduced in 3GPP Release 12, and enables a direct communication between proximal UEs, and data does not need to go through a base station (BS) or a core network.

A PRS and a sounding reference signal (SRS) are designed to transmit on the Uu link for positioning, while sidelink PRS is not designed. Therefore, it is advantage to provide methods and apparatus for transmitting the SL PRS.

### SUMMARY

Some embodiments of the present disclosure provide a user equipment (UE), which includes: a transceiver; and a processor coupled with the transceiver and configured to: obtain configuration information associated with a set of pairs of regions in time and frequency domains, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and determine a sidelink slot structure based on the configuration information.

In some embodiments, the processor of the UE is configured to: transmit a SCI transmission on the one or more resources within the first region; and transmit the one or more SL-PRS sets on the one or more resources within the second region.

In some embodiments, the processor of the UE is configured to: receive a SCI transmission on the one or more resources within the first region; and receive the one or more SL-PRS sets on the one or more resources within the second region.

In some embodiments, the SCI includes at least one of the following for a pair of regions within the set of pairs of regions: a set of indications of time domain resources of the one or more SL-PRS sets; a set of indications of frequency domain resources of the one or more SL-PRS sets; a set of comb sizes of the one or more SL-PRS sets; or a set of resource element (RE) offset values of the one or more SL-PRS sets.

In some embodiments, the configuration information includes at least one of the following for the each pair of regions: an indication indicating a set of indices of time domain resources and a set of indices of frequency domain resources for the one or more resources within the first region; a total number of resources for the set of SCI transmissions; a size of resources for each SCI transmission; a total number of SCI transmissions in the set of SCI transmissions; an indication indicating a set of indices of time domain resources and a set of indices of frequency domain resources for the one or more resources within the second region; a comb size of the one or more SL-PRS sets; a set of indices of time domain resources of the one or more SL-PRS sets; a set of indices of frequency domain resources of the one or more SL-PRS sets; a set of comb sizes of the one or more SL-PRS sets; a set of RE offset values of the one or more SL-PRS sets; or a bandwidth of the sidelink slot structure by a unit of sub-channel or resource block (RB).

In some embodiments, the set of indices of time domain resources includes one or more indices of symbols within the sidelink slot structure.

In some embodiments, the set of indices of frequency domain resources includes one or more indices of sub-channels or one or more indices of resource blocks (RB)s within the sidelink slot structure.

In some embodiments, the one or more indices of sub-channels or the one or more indices of RBs are continuous or discontinuous.

In some embodiments, the one or more resources within the first region and the one or more resources within the second region are multiplexed in the frequency domain or in the time domain.

In some embodiments, the configuration information further includes at least one of the following: a set of indications for one or more symbols for automatic gain control (AGC) in the sidelink slot structure; or a set of indications for one or more symbols for reception-transmission transition of the UE.

In some embodiments, the configuration information is received from a location management function (LMF), a BS, or another UE; or the configuration information is pre-configured to the UE.

In some embodiments, a first region of a first pair of regions of the set of pairs of regions and a first region of a second pair of regions of the set of pairs of regions are located in one of: continuous one or more sub-channels; discontinuous one or more sub-channels; continuous one or more RBs; or discontinuous one or more RBs.

Some embodiments of the present disclosure provide a network node, which includes: a transceiver; and a processor coupled with the transceiver and configured to: determine configuration information associated with a set of pairs of regions in time and frequency domains, wherein each pair of regions within the set of pairs of regions is associated with one or more resources within a first region and one or more resources within a second region, wherein the one or more resources within the first region are for a set of SCI transmissions, and wherein the one or more resources within the second region are for one or more SL-PRS sets associated with the set of SCI transmissions; and transmit the configuration information.

In some embodiments, the configuration information includes at least one of the following for the each pair of regions: an indication indicating a set of indices of time domain resources and a set of indices of frequency domain resources for the one or more resources within the first region; a total number of resources for the set of SCI transmissions; a size of resources for each SCI transmission; a total number of SCI transmissions in the set of SCI transmissions; an indication indicating a set of indices of time domain resources and a set of indices of frequency domain resources for the one or more resources within the second region; a comb size of the one or more SL-PRS sets; a set of indices of time domain resources of the one or more SL-PRS sets; a set of indices of frequency domain resources of the one or more SL-PRS sets; a set of comb sizes of the one or more SL-PRS sets; a set of RE offset values of the one or more SL-PRS sets; or a bandwidth of the sidelink slot structure by a unit of sub-channel or RB.

In some embodiments, the set of indices of time domain resources includes one or more indices of symbols within the sidelink slot structure.

In some embodiments, the set of indices of frequency domain resources includes one or more indices of sub-channels or one or more indices of resource blocks (RB)s within the sidelink slot structure.

In some embodiments, the one or more indices of sub-channels or the one or more indices of RBs are continuous or discontinuous.

In some embodiments, the one or more resources within the first region and the one or more resources within the second region are multiplexed in the frequency domain or in the time domain.

In some embodiments, the configuration information further includes at least one of the following: a set of indications for one or more symbols for AGC in the sidelink slot structure; or a set of indications for one or more symbols for reception-transmission transition of the UE.

In some embodiments, a first region of a first pair of regions of the set of pairs of regions and a first region of a second pair of regions of the set of pairs of regions are located in one of: continuous one or more sub-channels; discontinuous one or more sub-channels; continuous one or more RBs; or discontinuous one or more RBs.

In some embodiments, the network node is a LMF or a BS.

Some embodiments of the present disclosure provide a method performed by a UE, which includes: obtaining configuration information associated with a set of pairs of regions in time and frequency domains, wherein each pair of regions within the set of pairs of regions is associated with one or more resources within a first region and one or more resources within a second region, wherein the one or more resources within the first region are for a set of SCI transmissions, and wherein the one or more resources within the second region are for one or more SL-PRS sets associated with the set of SCI transmissions; and determining a sidelink slot structure based on the configuration information.

Some embodiments of the present disclosure provide a method performed by a network node, which includes: determining configuration information associated with a set of pairs of regions in time and frequency domains, wherein each pair of regions within the set of pairs of regions is associated with one or more resources within a first region and one or more resources within the second region, wherein the one or more resources within the first region are for a set of SCI transmissions, and wherein the one or more resources within the second region are for one or more SL-PRS sets associated with the set of SCI transmissions; and transmitting the configuration information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary wireless communication system according to some embodiments of the present disclosure.

FIG. 2 illustrates a flow chart of a method for transmitting a SL PRS according to some embodiments of the present disclosure.

FIG. 3 illustrates a flow chart of a method for transmitting a SL PRS according to some embodiments of the present disclosure.

FIGS. 4A-4I illustrate SL-PRS configuration information according to some embodiments of the present disclosure.

FIG. 5A illustrates a sidelink slot structure according to some embodiments of the present disclosure.

FIG. 5B illustrates a part of a sidelink slot structure of FIG. 5A according to some embodiments of the present disclosure.

FIG. 5C illustrates a structure of SL-PRS resource sets according to some embodiments of the present disclosure.

FIG. 6 illustrates a sidelink slot structure according to some embodiments of the present disclosure.

FIG. 7A illustrates a sidelink slot structure according to some embodiments of the present disclosure.

FIG. 7B illustrates a part of a sidelink slot structure of FIG. 7A according to some embodiments of the present disclosure.

FIG. 7C illustrates a structure of SL-PRS resource sets according to some embodiments of the present disclosure.

FIG. 8 illustrates a sidelink slot structure according to some embodiments of the present disclosure.

FIG. 9 illustrates a sidelink slot structure according to some embodiments of the present disclosure.

FIG. 10 illustrates a sidelink slot structure according to some embodiments of the present disclosure.

FIG. 11 illustrates a simplified block diagram of an exemplary apparatus according to some embodiments of the present disclosure.

### DETAILED DESCRIPTION

The detailed description of the appended drawings is intended as a description of the currently preferred embodiments of the present disclosure, and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Embodiments of the present disclosure may be provided in a network architecture that adopts various service scenarios, for example but not limited to, 3GPP 3G, LTE, LTE-Advanced (LTE-A), 3GPP 4G, 3GPP 5G NR, 3GPP Release 16 and onwards, etc. It is contemplated that along with the 3GPP and related communication technology development, the terminologies recited in the present disclosure may change, which should not affect the principle of the present disclosure.

Embodiments of the present disclosure may relate to coexistence between LTE V2X and NR V2X. It is contemplated that all embodiments in the present disclosure are also applicable to similar technical problems in coexistence between other different radio access technologies (RATs).

User equipment (UE) under NR V2X scenario and/or LTE V2X scenario may be referred to as V2X UE(s). A V2X UE which transmits data on sidelink may be referred to as a UE for transmitting, a transmitting UE, a transmitting V2X UE, a Tx UE, a V2X Tx UE, a sidelink (SL) Tx UE, or the like. A V2X UE which receives data on sidelink may be referred to as a UE for receiving, a receiving UE, a receiving V2X UE, an Rx UE, a V2X Rx UE, an SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present disclosure, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, V2X UE(s) may include wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via communication signals.

A BS under NR V2X scenario and/or LTE V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more V2X UEs via communication signals. For example, a BS may serve V2X UEs within a macro cell.

Sidelink communication between a Tx UE and a receive (Rx) UE under NR V2X scenario includes groupcast communication, unicast communication, or broadcast communication.

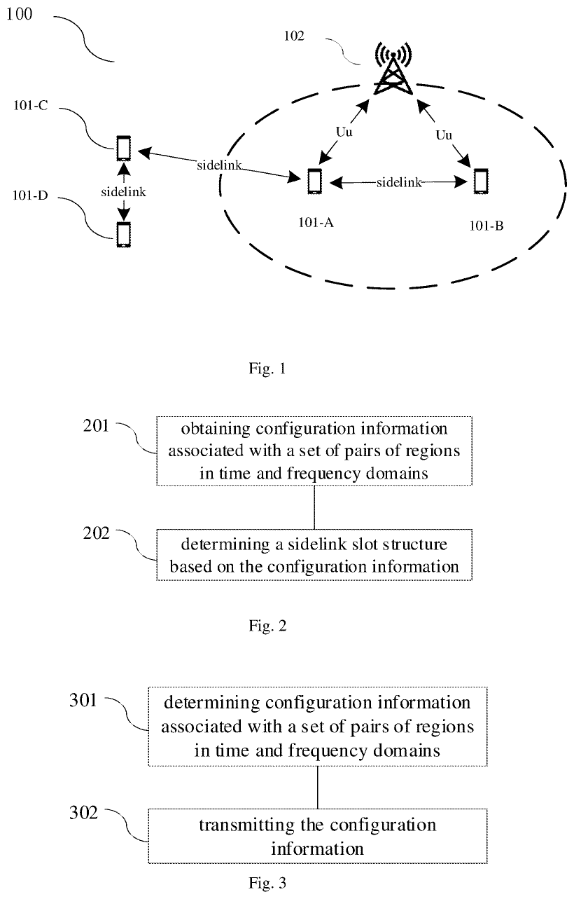

FIG. 1 illustrates an exemplary wireless communication system 100 (e.g., a V2X communication system) according to some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission. UE 101-A, UE 101-B, UE 101-C, and UE 101-D may be referred to as a V2X UE. It is contemplated that, in accordance with some other embodiments of the present disclosure, a V2X communication system may include more BSs and more or fewer V2X UEs.

In addition, although the V2X UEs as shown in FIG. 1 are illustrated in the shape of a cellphone, it is contemplated that a V2X communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange V2X messages with UE 101-B or UE 101-C through a sidelink using, for example, the NR technology or the LTE technology, through PC5 interface as defined in 3GPP documents. UE 101-A may transmit information or data to other UE(s) within the V2X communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

BS 102 as illustrated and shown in FIG. 1 may not be a specific base station, but may be any base station(s) in the V2X communication system. For example, assuming that the V2X communication system includes two BSs, UE 101-A being within a coverage area of any one the two BSs may be called as a case that UE 101-A is within the coverage of a BS in the V2X communication system; and only UE 101-A being outside of coverage area(s) of both BSs can be called as a case that UE 101-A is outside of the coverage of a BS in the V2X communication system.

UEs may operate in different modes. At least the following two sidelink resource allocation modes are defined for sidelink communication: resource allocation mode 1: a BS schedules a sidelink resource(s) to be used by a UE for sidelink transmission(s); and resource allocation mode 2: a UE determines a sidelink transmission resource(s) within sidelink resources configured by a BS or network, or pre-configured sidelink resources. In resource allocation mode 2, a BS does not schedule the sidelink resources for a UE. In FIG. 1, UE 101-A and UE 101-B may be in resource allocation mode 1, and UE 101-C and UE 101-D may be in resource allocation mode 2.

FIG. 2 illustrates a flow chart of a method for transmitting a SL PRS according to some embodiments of the present disclosure. The method of FIG. 2 may be performed by a UE, a Tx UE, or an Rx UE (e.g., UE 101-A as illustrated and shown in FIG. 1). Although described with respect to a UE, it should be understood that other devices may be configured to perform a method similar to that of FIG. 2.

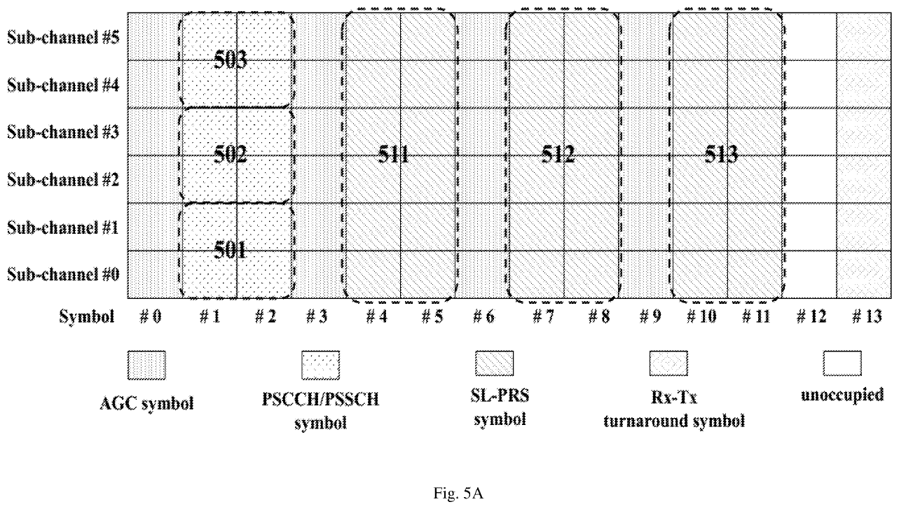

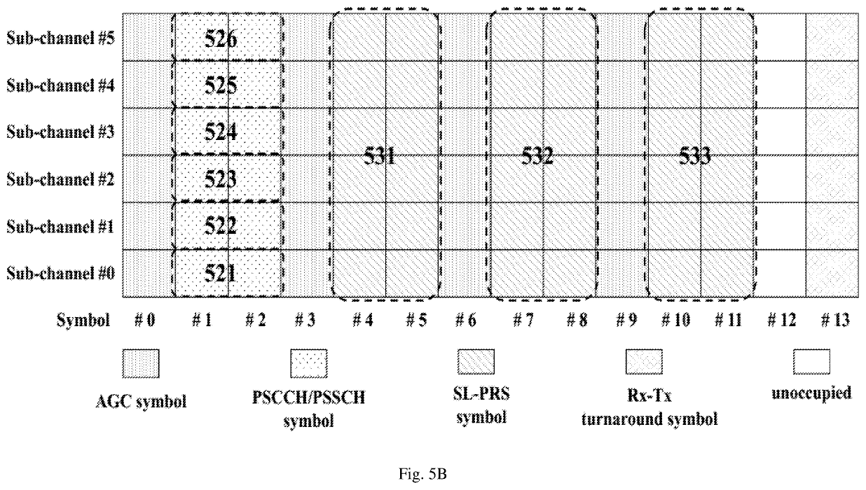

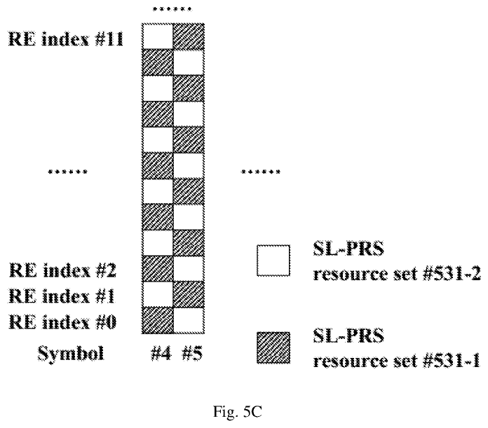

In operation 201, the UE may obtain configuration information associated with a set of pairs of regions in time and frequency domains. Each pair of regions within the set of pairs of regions is associated with one or more resources within a first region (e.g., a SCI region, hereinafter in the present disclosure, the first region and the SCI region may be used interchangeably when appropriate) and one or more resources within a second region (e.g., a SL-PRS region, hereinafter in the present disclosure, the second region and the SL-PRS region may be used interchangeably when appropriate). The one or more resources within the SCI region are for a set of SCI transmissions. The one or more resources within the SL-PRS region are for one or more SL-PRS sets associated with the set of SCI transmissions. In operation 202, the UE may determine a sidelink slot structure based on the configuration information. Specific examples are described in FIGS. 5A-10.

In some embodiments, the UE may transmit a SCI transmission on the one or more resources within the SCI region; and transmit the one or more SL-PRS sets on the one or more resources within the SL-PRS region. For example, a Tx UE such as UE 101-A, may transmit the SCI transmission on the one or more resources within the SCI region; and may transmit the one or more SL-PRS sets on the one or more resources within the SL-PRS region.

In some embodiments, the UE may receive a SCI transmission on the one or more resources within the SCI region; and receive the one or more SL-PRS sets on the one or more resources within the SL-PRS region. For example, an Rx UE such as UE 101-C, may receive the SCI transmission on the one or more resources within the SCI region from the Tx UE 101-A; and may receive the one or more SL-PRS sets on the one or more resources within the SL-PRS region.

In some embodiments, the SCI includes at least one of the following for a pair of regions within the set of pairs of regions:
a set of indications of time domain resources of the one or more SL-PRS sets;
a set of indications of frequency domain resources of the one or more SL-PRS sets;
a set of comb sizes of the one or more SL-PRS sets; or
a set of RE offset values of the one or more SL-PRS sets, specific examples are described in FIGS. 5A-10.

In some embodiments, the configuration information includes at least one of the following for the each pair of regions:
an indication indicating a set of indices of time domain resources and a set of indices of frequency domain resources for the one or more resources within the SCI region;
a total number of resources for the set of SCI transmissions;
a size of resources for each SCI transmission;
a total number of SCI transmissions in the set of SCI transmissions;
an indication indicating a set of indices of time domain resources and a set of indices of frequency domain resources for the one or more resources within the SL-PRS region;
a comb size of the one or more SL-PRS sets;
a set of indices of time domain resources of the one or more SL-PRS sets;
a set of indices of frequency domain resources of the one or more SL-PRS sets;
a set of comb sizes of the one or more SL-PRS sets;
a set of RE offset values of the one or more SL-PRS sets; or
a bandwidth of the sidelink slot structure by a unit of sub-channel or RB, specific examples are described in FIGS. 5A-10.

In some embodiments, the set of indices of time domain resources includes one or more indices of symbols within the sidelink slot structure, specific examples are described in FIGS. 5A-10.

In some embodiments, the set of indices of frequency domain resources includes one or more indices of sub-channels or one or more indices of resource blocks (RB)s within the sidelink slot structure.

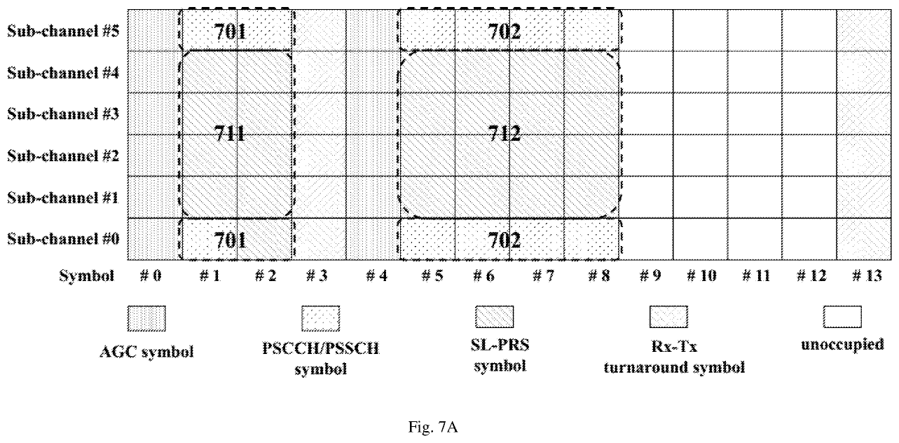

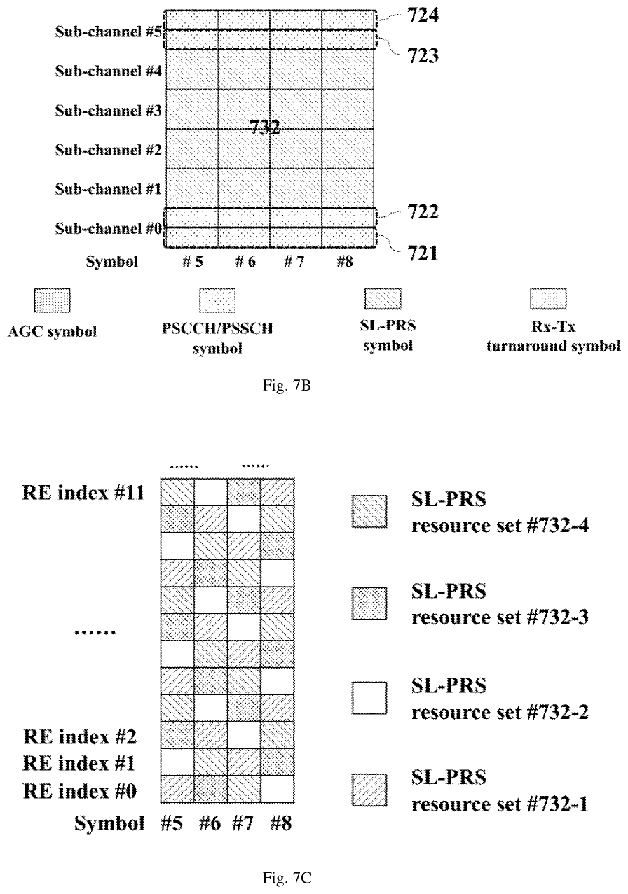

In some embodiments, the one or more indices of sub-channels or the one or more indices of RBs are continuous or discontinuous. In some scenarios, the sub-channels or RBs are interlaced. For example, in the embodiments of FIG. 7A, sub-channels of SCI region 701 are discontinuous, and sub-channels of SCI regions 701 and 702 are interlaced.

In some embodiments, one or more resources within the SCI region and the one or more resources within the SL-PRS region are multiplexed in the frequency domain or in the time domain. In other words, the resources in the SCI region are FDMed or TDMed with resources in the SL-PRS region.

In some embodiments, the configuration information further includes at least one of the following:
a set of indications for one or more symbols for AGC (e.g., AGC symbol(s) index) in the sidelink slot structure; or
a set of indications for one or more symbols for reception-transmission transition of the UE (e.g., Rx-Tx turnaround symbol(s) index or GAP symbol(s) index).

In some embodiments, the configuration information is received from a LMF, a BS (for example, BS 102 in FIG. 1), or another UE. In some other embodiments, the configuration information is pre-configured to the UE.

In some embodiments, a SCI region of a pair of regions of the set of pairs of regions and a SCI region of another pair of regions of the set of pairs of regions are located in one of:
continuous one or more sub-channels;
discontinuous one or more sub-channels;
continuous one or more RBs; or
discontinuous one or more RBs, specific examples are described in FIGS. 5A-10.

Details described in the embodiments of FIGS. 1, 3, and 5A-11 are applicable for the embodiments of FIG. 2. Moreover, details described in the embodiments of FIG. 2 are applicable for all the embodiments of FIGS. 1, 3, and 5A-11.

FIG. 3 illustrates a flow chart of a method for transmitting a SL PRS according to some embodiments of the present disclosure. The method of FIG. 3 may be performed by a network node, for example, a LMF or a BS (e.g., BS 102 as illustrated and shown in FIG. 1). Although described with respect to a network node, it should be understood that other devices may be configured to perform a method similar to that of FIG. 3.

In operation 301, a network node may determine configuration information associated with a set of pairs of regions in time and frequency domains. Each pair of regions within the set of pairs of regions is associated with one or more resources within a SCI region and one or more resources within a SL-PRS region. The one or more resources within the SCI region are for a set of SCI transmissions. The one or more resources within the SL-PRS region are for one or more SL-PRS sets associated with the set of SCI transmissions. In operation 302, the network node may transmit the configuration information.

In some embodiments, the configuration information includes at least one of the following for the each pair of regions:
an indication indicating a set of indices of time domain resources and a set of indices of frequency domain resources for the one or more resources within the first region;
a total number of resources for the set of SCI transmissions;
a size of resources for each SCI transmission;
a total number of SCI transmissions in the set of SCI transmissions;
an indication indicating a set of indices of time domain resources and a set of indices of frequency domain resources for the one or more resources within the second region;
a comb size of the one or more SL-PRS sets;
a set of indices of time domain resources of the one or more SL-PRS sets;
a set of indices of frequency domain resources of the one or more SL-PRS sets;
a set of comb sizes of the one or more SL-PRS sets;
a set of RE offset values of the one or more SL-PRS sets; or
a bandwidth of the sidelink slot structure by a unit of sub-channel or RB, specific examples are described in FIGS. 5A-10.

In some embodiments, the set of indices of time domain resources includes one or more indices of symbols within the sidelink slot structure, specific examples are described in FIGS. 5A-10.

In some embodiments, the set of indices of frequency domain resources includes one or more indices of sub-channels or one or more indices of RBs within the sidelink slot structure.

In some embodiments, the one or more indices of sub-channels or the one or more indices of RBs are continuous or discontinuous. In some scenarios, the sub-channels or RBs are interlaced. For example, in the embodiments of FIG. 7A, sub-channels of SCI region 701 are discontinuous, and sub-channels of SCI regions 701 and 702 are interlaced.

In some embodiments, one or more resources within the SCI region and the one or more resources within the SL-PRS region are multiplexed in the frequency domain or in the time domain. In other words, the resources in the SCI region are FDMed or TDMed with resources in the SL-PRS region.

In some embodiments, the configuration information further includes at least one of the following:
a set of indications for one or more symbols for AGC (e.g., AGC symbol(s) index) in the sidelink slot structure; or
a set of indications for one or more symbols for reception-transmission transition of the UE (e.g., Rx-Tx turnaround symbol(s) index or GAP symbol(s) index).

In some embodiments, a SCI region of a pair of regions of the set of pairs of regions and a SCI region of another pair of regions of the set of pairs of regions are located in one of:
continuous one or more sub-channels;
discontinuous one or more sub-channels;
continuous one or more RBs; or
discontinuous one or more RBs, specific examples are described in FIGS. 5A-10.

Details described in the embodiments of FIGS. 1, 2, and 5A-11 are applicable for the embodiments of FIG. 3. Moreover, details described in the embodiments of FIG. 3 are applicable for all the embodiments of FIGS. 1, 2, and 5A-11.

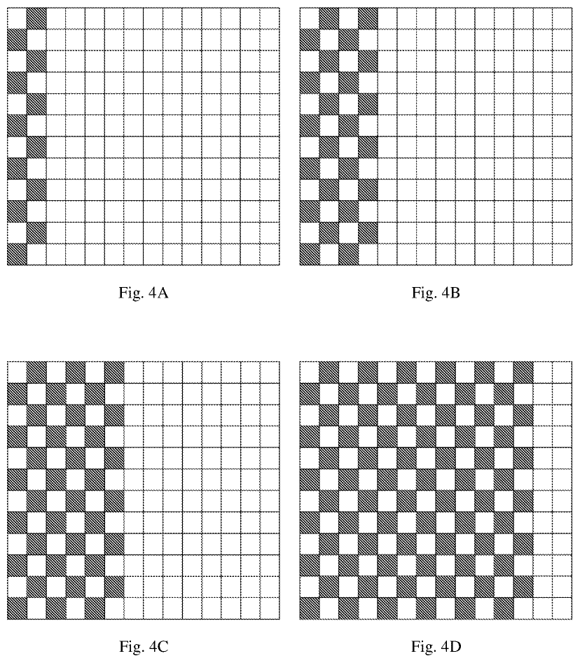

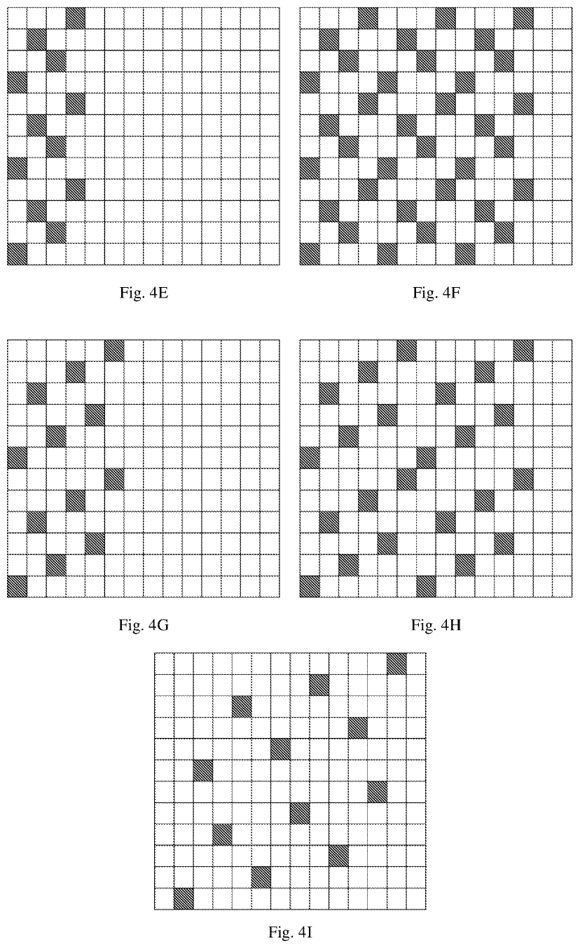

FIGS. 4A-4I illustrate SL-PRS configuration information according to some embodiments of the present application.

A SL-PRS may be transmitted in a dedicated SL-PRS resource pool, and related configuration information can be configured per a resource pool. The related configuration information may include at least one of:
(1) A start symbol of the SL-PRS in the time domain, which may be denoted as,

$${l}_{start}^{PRS} ,$$

is the first symbol of the downlink PRS within a slot and given by the higher-layer parameter dl-PRS-ResourceSymbolOffset-r16;
(2) A total number of SL-PRS symbols, which may be denoted as, LPRS, e.g., may be defined as any of {2, 4, 6, 12}. The total number of SL-PRS symbols may also be named as “a total number of symbols for a SL-PRS” or “a total symbol number of a SL-PRS” or the like.
(3) A comb size, e.g., {2, 4, 6, 12}, which may be denoted as,

$${K}_{comb}^{PRS} ,$$

as defined in 3GPP standard document TS38.214. The combination of

$$\{ {L}_{PRS} , {K}_{comb}^{PRS} \}$$

may be one of {2, 2}, {4, 2}, {6, 2}, {12, 2}, {4, 4}, {12, 4}, {6, 6}, {12, 6} or {12, 12};
(4) A SL-PRS RE offset set, which may be denoted as,

$${k}_{offset}^{PRS} ,$$

which may be a value from the set

$$\{ 0 , 1 , … , {K}_{comb}^{PRS} - 1 \} ,$$

and is given by a higher-layer parameter, e.g., dl-PRS-ReOffset-r16.

Table 1 below shows the total number of SL-PRS symbols and comb sizes illustrated in each figure of FIGS. 4A-4I.

TABLE 1

| | L_{PRS} = 2 | L_{PRS} = 4 | L_{PRS} = 6 | L_{PRS} = 12 |
|---|---|---|---|---|
| K_{comb}^{PRS} = 2 | FIG. 4A | FIG. 4B | FIG. 4C | FIG. 4D |
| K_{comb}^{PRS} = 4 | Not | FIG. 4E | Not | FIG. 4F |
| | applicable | | applicable | |
| K_{comb}^{PRS} = 6 | Not | Not | FIG. 4G | FIG. 4H |
| | applicable | applicable | | |
| K_{comb}^{PRS} = 12 | Not | Not | Not | FIG. 4I |
| | applicable | applicable | applicable | |

Each block in FIGS. 4A-4I may be referred to as a RE which may consist of one slot in time domain and one sub-subcarrier in frequency domain. Specifically, in time domain, there are 14 symbols, which may include symbol #0 to symbol #13 (the reference numerals are not shown in the drawings), in frequency domain, there are 12 sub-subcarriers in frequency domain, which may be from sub-subcarrier #0 to sub-subcarrier #11 (the reference numerals are not shown in the drawings).

In FIG. 4A, the total number of SL-PRS symbols is 2, the comb size is 2, and there are two offset values within the SL-PRS RE offset set, i.e., SL-PRS RE offset set={0, 1}. For offset value 0, the REs on the first symbol shown as black blocks may be used, for offset value 1, the REs on the second symbol shown as black blocks may be offset by one RE in frequency domain.

In FIG. 4B, the total number of SL-PRS symbols is 4, the comb size is 2, and there are four offset values within the SL-PRS RE offset set, i.e., SL-PRS RE offset set={0, 1, 0, 1}.

In FIG. 4C, the total number of SL-PRS symbols is 6, the comb size is 2, and there are six offset values within the SL-PRS RE offset set, i.e., SL-PRS RE offset set={0, 1, 0, 1, 0, 1}.

In FIG. 4D, the total number of SL-PRS symbols is 8, the comb size is 2, and there are eight offset values within the SL-PRS RE offset set, i.e., SL-PRS RE offset set={0, 1, 0, 1, 0, 1, 0, 1}.

In FIG. 4E, the total number of SL-PRS symbols is 4, the comb size is 4, and there are four offset values within the SL-PRS RE offset set, i.e., SL-PRS RE offset set={0, 2, 1, 3}. For offset value 0, the REs on the first symbol shown as black blocks may be used; for offset value 2, the REs shown on the second symbol as black blocks may be offset by two REs in frequency domain; for offset value 1, the REs on the third symbol shown as black blocks may be offset by one RE in frequency domain; and for offset value 3, the REs on the fourth symbol shown as black blocks may be offset by three REs in frequency domain.

In FIG. 4F, the total number of SL-PRS symbols is 12, the comb size is 4, and there are twelve offset values within the SL-PRS RE offset set, i.e., SL-PRS RE offset set={0, 2, 1, 3, 0, 2, 1, 3, 0, 2, 1, 3}.

In FIG. 4G, the total number of SL-PRS symbols is 6, the comb size is 6, and there are six offset values within the SL-PRS RE offset set, i.e., SL-PRS RE offset set={0, 3, 1, 4, 2, 5}.

In FIG. 4H, the total number of SL-PRS symbols is 12, the comb size is 6, and there are twelve offset values within the SL-PRS RE offset set, i.e., SL-PRS RE offset set={0, 3, 1, 4, 2, 5, 0, 3, 1, 4, 2, 5}.

In FIG. 4I, the total number of SL-PRS symbols is 12, the comb size is 12, and there are 12 offset values within the SL-PRS RE offset set, i.e., SL-PRS RE offset set={0, 6, 3, 9, 1, 7, 4, 10, 2, 8, 5, 11}.

The present disclosure proposes a sidelink slot structure wherein resources for the SCI transmission(s) and resources for the associated SL-PRS transmission(s) are multiplexed with FDM or TDM manner. The resources for the SCI transmission(s) may be in a SCI region, the resources for the associated SL-PRS transmission(s) may be in a SL-PRS region, and the SCI region is FDMed or TDMed with the associated SL-PRS region.

In order to multiplex the SCI region (which may also be referred to as the first region) with the associated SL-PRS region (which may also be referred to as the second region) in a sidelink slot structure, the sidelink slot structure may be configured or pre-configured to a UE. For a UE in resource allocation mode 1, such as UE 101-A in FIG. 1, the sidelink slot structure may be configured by the network, such as a LMF (not shown in FIG. 1) or a BS (such as BS 102 in FIG. 1), or by another UE (such as UE 101-B in FIG. 1). For a UE in resource allocation mode 2, such as UE 101-C in FIG. 1, the sidelink slot structure may be preconfigured to the UE by the LMF or by the BS, or configured by another UE (such as UE 101-D in FIG. 1).

The configuration information (or the pre-configuration information, hereinafter in the present disclosure, the configuration information and the pre-configuration information may be used interchangeably when appropriate) may be associated with a SCI region, which includes resources for SCI transmission (which includes physical sidelink control channel (PSCCH) transmission, physical sidelink shared channel (PSSCH) transmission, or both). The SCI region may be a region including one or more resources for SCI transmission. For example, the SCI may include the first stage SCI, which may be transmitted on the PSCCH, the SCI may also include the second stage SCI, which may be transmitted on the PSSCH, or both. The SCI may indicate the SL-PRS transmission on a SL-PRS region. The resources for the SCI region may include one or more sub-channels or RBs in frequency domain and one or more symbols in time domain, and may carry one or more SCI transmissions. The resources for SCI transmission may also be named as SCI resource sets or the like.

The configuration information may be associated with a SL-PRS region, which includes resources for SL-PRS transmission. The SL-PRS region may be a region including one or more resources for SL-PRS transmission(s). The resources for the SL-PRS region may include one or more sub-channels or RBs in frequency domain and one or more symbols in time domain, and may carry a number of SL-PRS transmissions. The resources for SL-PRS transmission may also be named as SL-PRS resource sets or the like. One specific example is described in embodiments of FIG. 5C.

As described above for FIGS. 2 and 3, the configuration information may include different elements. For example, the configuration information includes at least one of the following: one or more AGC symbols, and one or more Rx-Tx turnaround symbols (which may also be named as GAP symbol(s)). The configuration information may help to avoid the resource collision when multiple UEs perform the SCI transmitting and the associated SL-PRS transmission in the same slot.

FIGS. 5A and 5B illustrate a diagram of a sidelink slot structure according to some embodiments of the present disclosure. FIG. 5C illustrates a structure of SL-PRS resource sets according to some embodiments of the present disclosure. In FIGS. 5A and 5B, there are 14 symbols in one time slot, which are marked by #0, #1, #2, #3, #4, #5, #6, #7, #8, #9, #10, #11, #12, and #13, respectively. There are six sub-channels in frequency domain, which are marked by sub-channel #0, sub-channel #1, sub-channel #2, sub-channel #3, sub-channel #4, and sub-channel #5 respectively.

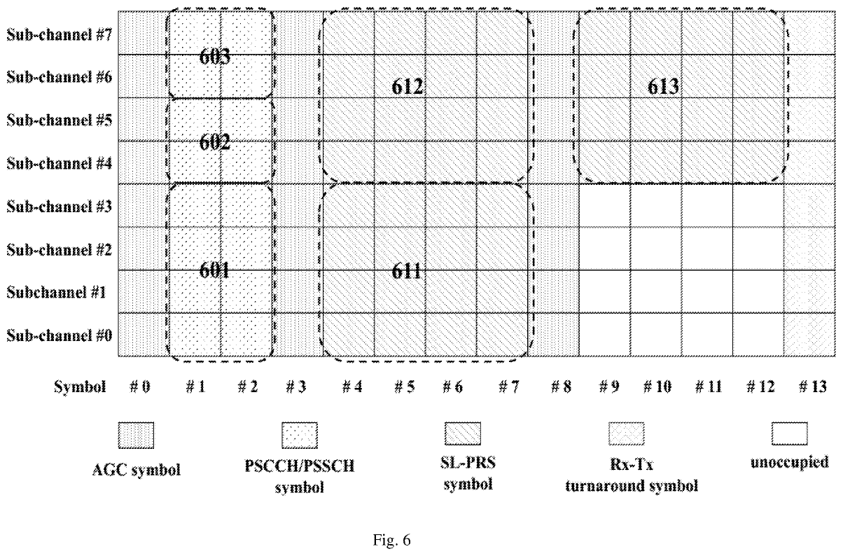

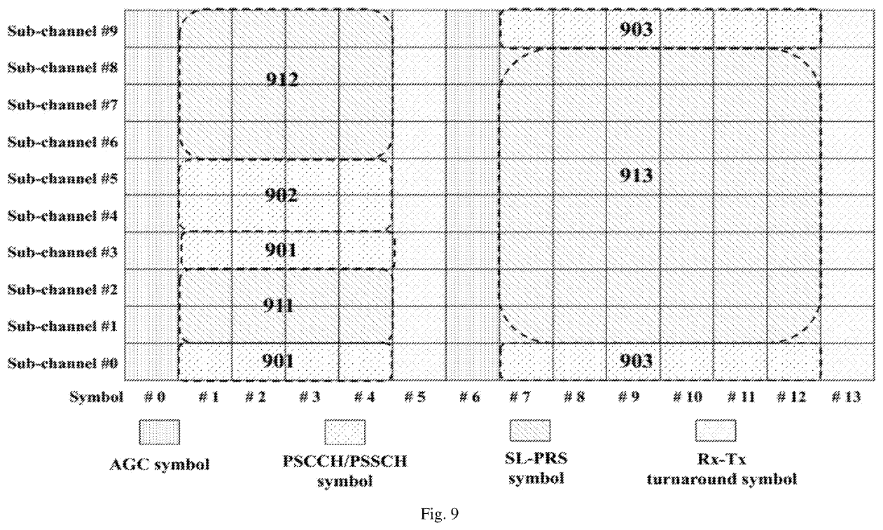

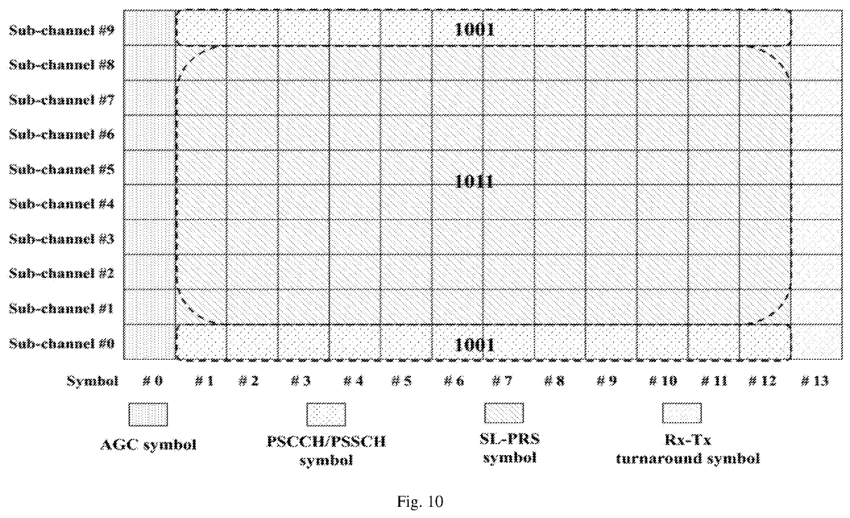

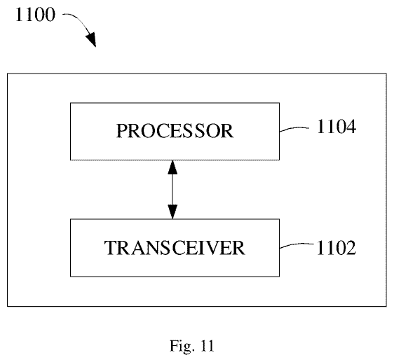

The present disclosure uses FIGS. 5A-5C as examples to further explain the configuration information for a set of pairs of SCI regions and SL-PRS regions. For one pair of a SCI region and a SL-PRS region, the configuration information may include at least one of the following:
A set of indications indicating a set of indices of time domain resources and a set of indices of frequency domain resources for the one or more resources within a SCI region, for example, SCI region 501, SCI region 502, or SCI region 503 in FIG. 5A. The set of indices of time domain resources may include one or more indices of symbols. In some embodiments, the set of indices of frequency domain resources may include one or more indices of sub-channels or one or more indices of RBs within the SCI region. Alternatively, in some other embodiments, in the case that the time domain resources of the SCI region are continuous, the set of indications may indicate the index of the time domain resource with the minimum index value (or maximum index value) in this SCI region, and a length of all the continuous time domain resources. Similarly, in the case that the frequency domain resources of the SCI region are continuous, the set of indications may indicate the index of the frequency domain resource with the minimum index value (or maximum index value) in this SCI region, and a length of all the continuous frequency domain resources.
For instance, in some embodiments of FIG. 5A, indices of sub-channel #0 and sub-channel #1 and indices of symbol #1 and symbol #2 are indicated as SCI region 501 for the SCI transmission. Indices of sub-channel #2 and sub-channel #3 and indices of symbol #1 and symbol #2 are indicated as SCI region 502 for the SCI transmission. Indices of sub-channel #4 and sub-channel #5 and indices of symbol #1 and symbol #2 are indicated as SCI region 503 for the SCI transmission.
In some other embodiments of FIG. 5A, an index of sub-channel #0 and the length of two sub-channels, and an index of symbol #1 and the length of two symbols are indicated as the SCI region 501 for the SCI transmission. An index of sub-channel #3 and two sub-channels, an index of symbol #1 and the length of two symbols are indicated as SCI region 502 for the SCI transmission. An index of sub-channel #4 and the length of two sub-channels, an index of symbol #1 and the length of two symbols are indicated as SCI region 503 for the SCI transmission.
A total number of resources for the set of SCI transmissions carried in the SCI region, and a size of resources for each SCI transmission in the set of SCI transmissions. Within each SCI region, there may be one or more SCI transmissions, which may include PSCCH resource, PSSCH resource, or PSCCH resource and PSSCH resource both, and each SCI transmission may occupy a SCI resource set. Accordingly, the SCI region includes a number of SCI resource sets for the set or of SCI transmissions. For example, in SCI region 501 in FIG. 5A, a total number of frequency domain resources are two sub-channels, and a size of resources for each SCI transmission is one sub-channel. Thus, based on this configuration information, it can be determined that the SCI region includes two SCI transmissions.
A total number of resources for the set of SCI transmissions carried in the SCI region, and a total number of SCI transmissions in the set of SCI transmissions. In an example as shown in FIG. 9, SCI region 903 includes two sub-channels (i.e., sub-channels #0 and #9) and the total number of SCI transmissions in SCI region 903 is 6. Thus, based on this configuration information, it can be determined that each SCI transmission occupies ⅓ sub-channel. For another example, the total number of frequency domain resources for the set of SCI transmissions may be one sub-channel, and the set of SCI transmissions includes 2 SCI transmissions. Thus, based on this configuration information, it can be determined that the frequency domain resources for each SCI transmission may include half of a sub-channel. Supposing that a sub-channel includes 10 RBs, each SCI transmission may include 5 RBs. In a further example, the total number of frequency domain resources for the set of SCI transmissions may also be represented by RBs.
An indication indicating a set of indices of time domain resources and a set of indices of frequency domain resources for the one or more resources within the SL-PRS region, for example, SL-PRS region 511, SL-PRS region 512, or SL-PRS region 513 in FIG. 5A. The set of indices of time domain resources may include one or more indices of symbols. The set of indices of frequency domain resources may include one or more indices of sub-channels, or one or more indices of RBs. In FIG. 5A, sub-channel #0 to sub-channel #5 on symbol #4 and symbol #5 are indicated as SL-PRS region 511 for the SL-PRS transmission(s). The indication may include indices of symbol #4 and symbol #5 and also include indices of sub-channel #0, sub-channel #1, sub-channel #2, sub-channel #3, sub-channel #4, and sub-channel #5 for the resources within SL-PRS region 511. Sub-channel #0 to sub-channel #5 on symbol #7 and symbol #8 are indicated as SL-PRS region 512 for the SL-PRS transmission(s). Sub-channel #0 to sub-channel #5 on symbol #10 and symbol #11 are indicated as SL-PRS region 513 for the SL-PRS transmission(s).
Alternatively, in the case that the time domain resources of the SL-PRS region are continuous, the set of indications may indicate the index of the time domain resource with the minimum index value (or maximum index value) in this SCI region, and a length of all the continuous time domain resources. Similarly, in the case that the frequency domain resources of the SL-PRS region are continuous, the set of indications may indicate the index of the frequency domain resource with the minimum index value (or maximum index value) in this SCI region, and a length of all the continuous frequency domain resources. The indication may include the index of symbol #4 and 2 symbols, and the index of sub-channel #0 and 6 sub-channels for the resources within SL-PRS region 511.
A comb size of the one or more SL-PRS sets. In FIG. 5A, the region including frequency domain resources from sub-channel #0 to #5 and time domain resources from symbol #4 to symbol #5 is indicated as SL-PRS region 511 for transmitting the SL-PRS sets with comb size=2. The region including frequency domain resources from sub-channel #0 to #5 and time domain resources from symbol #7 to symbol #8 is indicated as SL-PRS region 512 for transmitting the SL-PRS sets with comb size=2. The region including frequency domain resources from sub-channel #0 to #5 and frequency domain resources from symbol #10 to symbol #11 is indicated as SL-PRS region 513 for transmitting the SL-PRS sets with comb size=2. In each SL-PRS region in the embodiments of FIG. 5A, multiple sets of SL-PRS resources are assigned with the same comb size and different RE offset values, i.e., the multiple sets of SL-PRS resources in each SL-PRS region are orthogonal in time and frequency domain.
A set of indices of time domain resources of the one or more SL-PRS sets. For example, the indices of time domain resources of SL-PRS resource set #531-1 as shown in FIG. 5C is symbol #4 and symbol #5.
A set of indices of frequency domain resources of the one or more SL-PRS sets. For example, the indices of frequency domain resources of SL-PRS resource set(s) included in SL-PRS region 511 as shown in FIG. 5A is sub-channel #0, sub-channel #1, sub-channel #2, sub-channel #3, sub-channel #4, and sub-channel #5.
A set of comb sizes of the one or more SL-PRS sets. For example, in FIGS. 5A-5C, for SL-PRS resource set on symbol #4 and symbol #5, the comb size is 2. For SL-PRS resource set on symbol #7 and symbol #8, the comb size is 2. For SL-PRS resource set on symbol #10 and symbol #11, the comb size is 2. The set of comb sizes may include {2, 2, 2}. Although only one comb size is illustrated in FIGS. 5A-5C, other comb sizes, such as 4 in FIG. 6, 12 in FIG. 10, are also illustrated. Other values of comb sizes and other values of symbols may also be applied when appropriate.
A set of RE offset values of the one or more SL-PRS sets. For example, for SL-PRS resource set on symbol #4 and symbol #5, the set of RE offset is 10, 11. For SL-PRS resource set on symbol #7 and symbol #8, the set of RE offset is 10, 11. For SL-PRS resource set on symbol #10 and symbol #11, the set of RE offset is 10, 11. Other set of RE offset values of the one or more SL-PRS sets may refer to those shown in FIGS. 4A-4I.
A bandwidth of the sidelink slot structure by a unit of sub-channel or RB. For example, the bandwidth of the sidelink slot structure in FIG. 5A is 6 sub-channels.

It should be noted that the above detailed values are only exemplary, and the detailed values in the configuration information may include other values.

The configuration information may also indicate an association relation between a SCI region and a SL-PRS region. For example, one SCI region is paired with one SL-PRS region. In FIG. 5A, SCI region 501 is paired with SL-PRS region 511, SCI region 502 is paired with SL-PRS region 512, SCI region 503 is paired with SL-PRS region 513, etc. This relation may not be explicitly indicated, and may be determined by the UE by the identity information of the regions, such as the regions with the same last number (or with the same label, etc.) are paired. For another example, SCI region #1 is paired with SCI region #1, or the like. Alternatively, the configuration information may specifically indicate the association relation, such as an additional indication is provided for indicating that SCI region #1 is associated with SCI region #1, or the like.

For one pair of a SCI region and a SL-PRS region, the configuration information may further include at least one of the following:
A set of indications for one or more symbols for AGC in the sidelink slot structure. For example, in FIG. 5A, the AGC symbols may include symbol #0, #3, #6, and #9. Alternatively, the AGC symbols may not be indicated, and the AGC symbol may be located before the SCI region and the SL-PRS region as default. That is, in FIG. 5A, before SCI region 501, 502, or 503, before SL-PRS region 511, 512, or 513, there are symbol #0, #3, #6, and #9, which are considered as AGC symbols in the case that there is no specific indication.
A set of indications for one or more symbols for reception-transmission (Rx-Tx) transition of the UE. The symbols may also be referred to as a gap symbol or other names. For example, in FIG. 5A, symbol #13 is indicated as the Rx-Tx turnaround symbol.

Regarding the resources which are not indicated in the configuration information, they may be unoccupied. For example, the resources in symbol #12 from sub-channel #0 to sub-channel #5 in FIG. 5A are unoccupied.

### Solution 1

In solution 1, the SCI region is TDMed with the associated SL-PRS region in a sidelink slot structure. The present disclosure uses FIGS. 5A-6 as examples to further explain the configuration information. For example, in FIG. 5A, SCI region 501 is TDMed with SL-PRS region 511, SCI region 502 is TDMed with SL-PRS region 512, and SCI region 503 is TDMed with SL-PRS region 513.

Within one SCI region, there may be one or more SCI transmissions, and there may be the same number of SCI resource sets for the SCI transmissions. The SCI resource sets may be FDMed by multiple UEs for their own SCI transmissions, and each SCI resource set may be used by a UE, to perform the SCI transmission so as to indicate the associated SL-PRS transmissions on the corresponding SL-PRS resource set in the SL-PRS region. In the SCI region in FIG. 5A, there are two SCI resource sets in each SCI region, and details are shown in FIG. 5B. That is, in SCI region 501, there are two SCI transmissions, and the SCI transmission resource sets are FDMed in the SCI region, as can be seen, SCI transmission resource 521 and SCI transmission resource 522 as shown in FIG. 5B are FDMed in SCI region 501 as shown in FIG. 5A. Similarly, SCI transmission resource 523 and SCI transmission resource 524 as shown in FIG. 5B are FDMed in SCI region 502 as shown in FIG. 5A, and SCI transmission resource 525 and SCI transmission resource 526 as shown in FIG. 5B are FDMed in SCI region 503 as shown in FIG. 5A. That is, SCI resource sets in SCI regions 501, 502, and 503 in FIG. 5A can be FDMed by 6 UEs in total as shown in FIG. 5B.

In some embodiments, a total number of SCI transmissions in one SCI region is equal to the comb size of the SL-PRS sets in the associated SL-PRS region. The configuration information will configure the same number for the total number of SCI transmissions in one SCI region and for the comb size of the SL-PRS sets in the associated SL-PRS region. For example, there are 2 SCI transmissions in SCI region 501 in FIG. 5A, correspondingly, the comb size of the SL-PRS sets for SL-PRS region 511 is 2. The comb size indicates the total number of SL-PRS sets in the SL-PRS region. For example, the comb size of 2 means that there are two SL-PRS sets in the SL-PRS region, and the SL-PRS RE offset may be 0 and 1 respectively.

FIG. 5C illustrates the structure of SL-PRS resource sets (i.e., SL-PRS resource sets #531-1 and #531-2) on two symbols in time domain and one RB in a sub-channel in frequency domain (i.e., SL-PRS resource sets within SL-PRS resource 531 as shown in FIG. 5B). One RB includes 12 REs, which are marked by RE index #0, RE index #1, . . . , RE index #11.

According to the SL-PRS configuration information in FIG. 4A, in which the total number of SL-PRS symbols is 2, and the comb size is 2, for each RB on symbol #4-symbol #5 and sub-channel #0-sub-channel #5, with SL-PRS RE offset set=0, a UE (e.g., UE 101-A) may determine the SL-PRS resource set 531-1 including the REs with blocks of dashed lines. Accordingly, the UE may transmit the SCI on the SCI resource 521 in FIG. 5B, to indicate the associated SL-PRS transmission on SL-PRS resource set #531-1 for each RB in SL-PRS resource set 531. A further UE (e.g., UE 101-B) may determine the SL-PRS resource set #531-2 including the REs which are shown as white blocks. The further UE may transmit the SCI on the SCI resource 522 to indicate the associated SL-PRS transmission on SL-PRS resource set #531-2 for each RB in SL-PRS resource set 531.

In conclusion, at the UE side, after receiving the configuration information, the UE may determine the sidelink slot structure, which may at least include a pair of SCI region and a SL-PRS region. Taking SCI region 501 in FIG. 5A as an example, there are two SCI transmissions in SCI region 501, thus, two UEs, e.g., UE 101-A and UE 101-B, may both transmit its SCI transmission in SCI region 501. As shown in FIG. 5B, SCI region 501 includes two SCI transmission resources 521 and 522. UE 101-A may transmit the SCI transmission with resource included in SCI transmission resource 521. UE 101-A may transmit the SCI transmission with resource included in SCI transmission resource 522. Based on the comb size (e.g., 2) and the RE offset value (e.g., 0), UE 101-A may use SL-PRS resource set #531-1 (including the REs which are shown as blocks with left dashed lines) as shown in FIG. 5C, to perform the SL-PRS transmission. Similarly, UE 101-B may determine the SL-PRS resource set #531-2 including the REs which are shown as white blocks in FIG. 5C. UE 101-B may transmit the SCI on the SCI resource 522 to indicate the associated SL-PRS transmission on SL-PRS resource set #531-2.

In some embodiments, after determining the sidelink slot structure, UE1, which may be a Tx UE, and it may transmit the SCI information on one or more resources of a SCI region to other UE, and the SCI may include at least one of the following:
a set of indications of time domain resources of the one or more SL-PRS sets;
a set of indications of frequency domain resources of the one or more SL-PRS sets;
a set of comb sizes of the one or more SL-PRS sets; or
a set of RE offset values of the one or more SL-PRS sets.

The Tx UE then may transmit the SL-PRS sets on the one or more resources within the SL-PRS region.

Correspondingly, at Rx UE side, the Rx UE may receive the SCI transmission on the one or more resources within the SCI region; and receive the one or more SL-PRS sets on the one or more resources within the SL-PRS region

FIG. 6 illustrates a sidelink slot structure according to some embodiments of the present disclosure. The embodiments of FIG. 6 refer to a sidelink slot structure for SCI region(s) TDMed with its associated SL-PRS region(s).

As shown in FIG. 6, there are 14 symbols in one time slot in time domain, which are marked by #0 to #13, respectively. There are eight sub-channels in frequency domain, which are marked by sub-channel #0 to channel #7 respectively.

The set of indices of time domain resources of SCI region 601 in FIG. 6 includes symbol #1 and symbol #2; the set of indices of frequency domain resources of SCI region 601 includes sub-channel #0, sub-channel #1, sub-channel #2, and sub-channel #3; and the total number of SCI transmissions in SCI region 601 is 4. In frequency domain, multiple SCI transmissions may share RBs in all sub-channels equally, and the RBs for one SCI transmission may be calculated as follows: a total number of RBs for one SCI transmission=¼ of a total number of RBs of sub-channel #0, sub-channel #1, sub-channel #2, and sub-channel #3. For example, the first SCI transmission may use all the RBs of sub-channel #0; the second SCI transmission may use all the RBs of sub-channel #1; the third SCI transmission may use all the RBs of sub-channel #2; and the fourth SCI transmission may use all the RBs of sub-channel #3.

The set of indices of time domain resources of SL-PRS region 611 in FIG. 6 includes symbol #4, symbol #5, symbol #6, and symbol #7; the set of indices of frequency domain resources of SL-PRS region 611 includes sub-channel #0, sub-channel #1, sub-channel #2, and sub-channel #3; and the comb size is 4. The comb size of the SL-PRS sets of SL-PRS region 611 is equal to the total number of SCI transmissions in SCI region 601.

The set of indices of time domain resources of SCI region 602 in FIG. 6 includes symbol #1 and symbol 2; the set of indices of frequency domain resources of SCI region 602 includes sub-channel #4 and sub-channel #5; and the total number of SCI transmissions in SCI region 602 is 2.

The set of indices of time domain resources of SL-PRS region 612 in FIG. 6 includes symbol #4, symbol #5, symbol #6, and symbol #7; the set of indices of frequency domain resources of SL-PRS region 612 includes sub-channel #4, sub-channel #5, sub-channel #6, and sub-channel #7; and the comb size is 2.

The set of indices of time domain resources of SCI region 603 in FIG. 6, includes symbol #1 and symbol 2; the set of indices of frequency domain resources of SCI region 603, includes sub-channel #6 and sub-channel #7; and the total number of SCI transmissions in SCI region #3 is 2.

The set of indices of time domain resources of SL-PRS region 613 in FIG. 6 includes symbol #9, symbol #10, symbol #11, and symbol #12; the set of indices of frequency domain resources of SL-PRS region 613 includes sub-channel #4, sub-channel #5, sub-channel #6, and sub-channel #7; and the comb size is 2.

Optionally, the configuration information further indicates the indices of the AGC symbols, which include symbol #0, symbol #3, and symbol #8; the index of the Rx-Tx turnaround symbol, which is symbol #13, and indicates indices of the bandwidth of this SL-PRS slot by the unit of sub-channel, which includes: sub-channel #0, sub-channel #1, sub-channel #2, sub-channel #3, sub-channel #4, sub-channel #5, sub-channel #6, and sub-channel #7.

In conclusion, the configuration information for the sidelink slot structure in FIG. 6 may include the following:

```
“SL-PRS slot structure configuration #1,
{
      SCI region 601, sub-channel index, symbol index, total number of SCI
transmission
  {
    sub-channel #0, sub-channel #1, sub-channel #2, sub-channel #3,
    symbol #1, symbol #2
    total number of SCI transmission = 4 (e.g., a total number of RBs for each SCI
    transmission = 1/4 of a total number of RBs of sub-channel #0, sub-channel #1,
    sub-channel #2, and sub-channel #3)
  }
  SL-PRS region 611, sub-channel index, symbol index, comb type
  {
  sub-channel #0, sub-channel #1, sub-channel #2, sub-channel #3,
  symbol #4, symbol #5, symbol #6, symbol #7,
  comb size =4
  }
      SCI region 602, sub-channel index, symbol index, total number of SCI
transmission
  {
    sub-channel #4, sub-channel #5,
    symbol #1, symbol #2
    total number of SCI transmission = 2 (e.g., a total number of RBs for each SCI
    transmission = 1/2 of a total number of RBs of sub-channel #4 and sub-channel
    #5)
    }
  SL-PRS region 612, sub-channel index, symbol index, comb type
  {
  sub-channel #4, sub-channel #5, sub-channel #6, sub-channel #7,
  symbol #4, symbol #5, symbol #6, symbol #7,
  comb size =2
  }
      SCI region 603, sub-channel index, symbol index, total number of SCI
transmission
  {
    sub-channel #6, sub-channel #7,
    symbol #1, symbol #2
    total number of SCI transmission = 2 (e.g., a total number of RBs for each SCI
    transmission = 1/2 of a total number of RBs of sub-channel #6 and sub-channel
    #7)
  }
  SL-PRS region 613, sub-channel index, symbol index, comb type
  {
  sub-channel #4, sub-channel #5, sub-channel #6, sub-channel #7,
  symbol #9, symbol #10, symbol #11, symbol #12,
  comb size =2
  }
  AGC symbol(s) index
  {symbol #0, symbol #3, symbol#8}
  Rx-Tx turnaround symbol(s) index
  {symbol #13}
  the bandwidth of this SL-PRS slot by the unit of sub-channel,
  {
  sub-channel #0, sub-channel #1, sub-channel #2, sub-channel #3, sub-channel #4,
  sub-channel #5, sub-channel #6, sub-channel #7
  }
}”
```

### Solution 2

In solution 2, the SCI region is FDMed with the associated SL-PRS region.

The configuration information is similar to that in solution 1, and the difference is: the SCI region is FDMed with the associated SL-PRS region in the sidelink slot structure, and the present disclosure uses FIGS. 7A-7C as examples to further explain the configuration information.

FIGS. 7A and 7B illustrates a sidelink slot structure according to some embodiments of the present disclosure.

There are 14 symbols in one time slot in time domain, which are marked by #0 to #13, respectively. There are six sub-channels in frequency domain, which are marked by sub-channel #0 to sub-channel #5 respectively.

According to the configuration information, symbol #0 and symbol #4 in all sub-bands are the AGC symbols, symbol #3 and symbol #13 in all sub-bands are the Rx-Tx turnaround symbols, symbol #9 to symbol #11 in all sub-bands are unoccupied symbols. Sub-channel #0 and sub-channel #5 on symbol #1 and symbol #2 are indicated as SCI region 701 for transmitting the SCI to indicate the SL-PRS transmission on SL-PRS region 711. Sub-channel #0 and sub-channel #5 on symbol #5 to #8 are indicated as SCI region 702 for transmitting the SCI to indicate the SL-PRS transmission on SL-PRS region 712. As can be seen, the SCI region and the associated SL-PRS region are FDMed.

Further, the frequency resources for one SCI region may be discontinuous and located on both sides of the associated SL-PRS region. For example, SCI region 701 is discontinuous in frequency domain and located on both sides of the associated SL-PRS region 711. SCI region 702 is discontinuous in frequency domain and located on both sides of the associated SL-PRS region 712.

Taking SCI region 702 as an example, there are four SCI transmissions in SCI region 702, and the resources for the four SCI transmissions are FDMed, as shown in FIG. 7B. Therefore, the resource set for the first SCI transmission include first half sub-channel of sub-channel #0 on symbol #5 to symbol #8, i.e., the resource set 721. The resources set for the second SCI transmission include the second half sub-channel of sub-channel #0 on symbol #5 to symbol #8, i.e., the resource set 722. The resource set for the third SCI transmission include first half sub-channel of sub-channel #5 on symbol #5 to symbol #8, i.e., the resource set 723. The resources set for the fourth SCI transmission include the second half sub-channel of sub-channel #5 on symbol #5 to symbol #8, i.e., the resource set 724. Regarding the half sub-channel, supposing that one sub-channel includes 10 RBs, RB #0 to RB #4 are the first half sub-channel of sub-channel #0, RB #5 to RB #9 are the second half sub-channel of sub-channel #0.

According to configuration information, sub-channel #1 to sub-channel #4 on symbol #1 and symbol #2 are indicated as SL-PRS region 711, and the comb size is 2. Sub-channel #1 to sub-channel #4 on symbol #5 to symbol #8 are indicated as SL-PRS region 712, and the comb size is 4.

FIG. 7C illustrates a structure of SL-PRS resource sets according to some embodiments of the present disclosure. Specifically, FIG. 7C illustrates the structure of SL-PRS resource sets (i.e., SL-PRS resource sets #731-1 to #731-4) on symbol #5 to symbol #8 in time domain and one RB in frequency domain (i.e., SL-PRS resource sets within SL-PRS resource 732 as shown in FIG. 7B). One RB includes 12 REs, which are marked by RE index #0, RE index #1, . . . , RE index #11.

According to the SL-PRS configuration information in FIG. 4E, in which the total number of SL-PRS symbols is 4, and the comb size is 4, for each RB on symbol #5-symbol #8 and sub-channel #0-sub-channel #5, with SL-PRS RE offset set=0, UE1 (e.g., UE 101-A) may determine the SL-PRS resource set #732-1 as the REs with left dashed lines. Accordingly, UE1 may transmit the SCI transmission on the SCI resource set 721 to indicate the associated SL-PRS transmission on SL-PRS resource set #732-1 for each RB in SL-PRS resource 732.

Similarly, UE2 (e.g., UE 101-B) may determine the resource for SL-PRS transmission on symbol #5 to symbol #8 with comb size=4 and RE offset value=1, i.e., the SL-PRS resource set #732-2 as the REs which are shown as white blocks. UE2 may transmit the SCI transmission on the SCI resource set 722 to indicate the associated SL-PRS transmission on SL-PRS resource set #732-2 for each RB in SL-PRS resource 732. UE3 (e.g., UE 101-C) may determine the resource for SL-PRS transmission on symbol #5 to symbol #8 with comb size=4 and RE offset value=2, i.e., SL-PRS resource set #732-3 as the REs which are shown as dots. UE3 may transmit the SCI transmission on the SCI resource set 723 to indicate the associated SL-PRS transmission on SL-PRS resource set #733-2 for each RB in SL-PRS resource 732. UE4 (e.g., UE 101-D) may determine the resource for SL-PRS transmission on symbol #5 to symbol #8 with comb size=4 and RE offset value=3, i.e., SL-PRS resource set #732-4 as the REs which are shown as right dashed lines. UE4 may transmit the SCI transmission on the SCI resource set 724 to indicate the associated SL-PRS transmission on SL-PRS resource set #732-4 for each RB in SL-PRS resource 732.

In FIG. 7A, the frequency domain resources of the SCI region are on both sides of the associated SL-PRS region, for example, the frequency domain resources of SCI region 701 include sub-channel #0 and sub-channel #5, and the frequency domain resources of the associated SL-PRS region include sub-channel #1 to sub-channel #4.

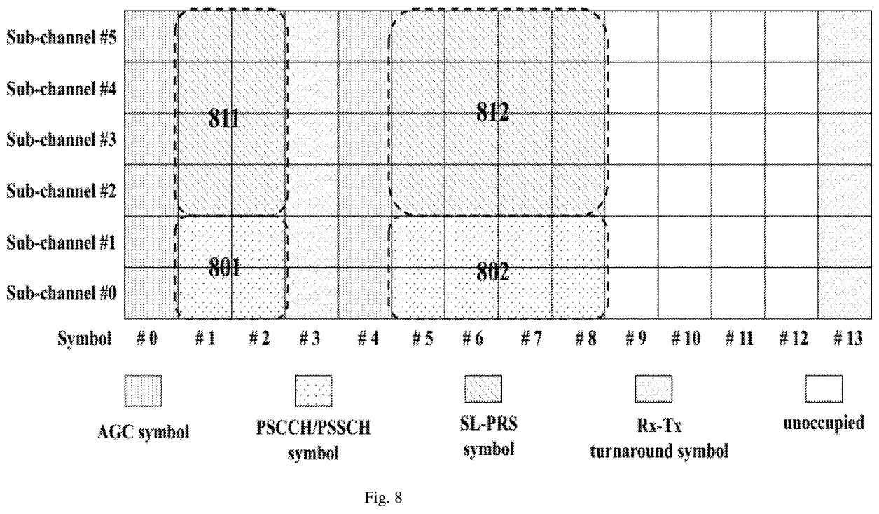

In some other scenarios, the frequency domain resources of the SCI region may be on one side of the associated SL-PRS region. For example, FIG. 8 as follows shows such a scenario.

FIG. 8 illustrates a sidelink slot structure according to some embodiments of the present disclosure.

There are 14 symbols in one time slot in time domain, which are marked by #0 to #13, respectively. There are six sub-channels in frequency domain, which are marked by sub-channel #0 to channel #5, respectively.

The set of indices of time domain resources of SCI region, which is marked by 801 in FIG. 8, includes symbol #1 and symbol #2; the set of indices of frequency domain resources of SCI region 801 includes sub-channel #0 and sub-channel #2; and the total number of SCI transmission in SCI region 801 is 2. The set of indices of time domain resources of SL-PRS region, which is marked by 811 in FIG. 8, includes symbol #1 and symbol #2; the set of indices of frequency domain resources of SL-PRS region 811, includes sub-channel #2, sub-channel #3, sub-channel #4, and sub-channel #5; and the comb size is 2. As can be seen, the frequency domain resources of the SCI region 801 are on one side of the associated SL-PRS region 802.

The set of indices of time domain resources of SCI region, which is marked by 802 in FIG. 8, includes symbol #5, symbol #6, symbol #7, and symbol #8; the set of indices of frequency domain resources of SCI region 802 includes sub-channel #0 and sub-channel #1; and the total number of SCI transmissions in SCI region #1 is 4. The set of indices of time domain resources of SL-PRS region, which is marked by 812 in FIG. 8, includes symbol #5, symbol #6, symbol #7, and symbol #8; the set of indices of frequency domain resources of SL-PRS region 811, includes sub-channel #2, sub-channel #3, sub-channel #4, and sub-channel #5; and the comb size is 4. As can be seen, the frequency domain resources of the SCI region may be on one side of the associated SL-PRS region. As can be seen, the frequency domain resources of the SCI region 802 are on one side of the associated SL-PRS region 812.

FIG. 9 illustrates a sidelink slot structure according to some embodiments of the present disclosure.

There are 14 symbols in one time slot in time domain, which are marked by #0 to #13, respectively. There are eight sub-channels in frequency domain, which are marked by sub-channel #0 to channel #7, respectively.

The set of indices of time domain resources of SCI region 901 in FIG. 9 includes symbol #1, symbol #2, symbol #3, and symbol #4; the set of indices of frequency domain resources of SCI region 901 includes sub-channel #0, and sub-channel #3; and the total number of SCI transmissions in SCI region 901 is 2. In frequency domain, multiple SCI transmissions may share RBs in all sub-channels equally, and the RBs for one SCI transmission may be calculated as follows: a total number of RBs for one SCI transmission=½ of a total number of RBs of sub-channel #0 and sub-channel #3. For example, the first SCI transmission may use all the RBs of sub-channel #0; and the second SCI transmission may use all the RBs of sub-channel #3.

The set of indices of time domain resources of SL-PRS region 911 in FIG. 9 includes symbol #1, symbol #2, symbol #3, and symbol #4; the set of indices of frequency domain resources of SL-PRS region 911 includes sub-channel #1, and sub-channel #2; and the comb size is 2.

The set of indices of time domain resources of SCI region 902 in FIG. 9 includes symbol #1, symbol #2, symbol #3, and symbol #4; the set of indices of frequency domain resources of SCI region 902 includes sub-channel #4 and sub-channel #5; and the total number of SCI transmissions in SCI region 902 is 4.

The set of indices of time domain resources of SL-PRS region 912 in FIG. 9, includes symbol #1, symbol #2, symbol #3, and symbol #4; the set of indices of frequency domain resources of SL-PRS region 912, includes sub-channel #6, sub-channel #7, sub-channel #8, and sub-channel #9; and the comb size is 4.

The set of indices of time domain resources of SCI region 903 in FIG. 9 includes symbol #7, symbol #8, symbol #9, symbol #10, symbol #11, and symbol #12; the set of indices of frequency domain resources of SCI region 903 includes sub-channel #0 and sub-channel #9; and the total number of SCI transmission in SCI region 903 is 6. Each SCI transmission occupies ⅓ sub-channel. Regarding one sub-channel including 12 RBs, a total number of RBs for one SCI transmission=(⅓)×12=4. Thus, RB #0 to RB #3 are the first ⅓ sub-channel of sub-channel #0, RB #4 to RB #7 are the second ⅓ sub-channel of sub-channel #0, and RB #8 to RB #11 are the last ⅓ sub-channel of sub-channel #0.

The set of indices of time domain resources of SL-PRS region 913 in FIG. 9 includes symbol #7, symbol #8, symbol #9, symbol #10, symbol #11, and symbol #12; the set of indices of frequency domain resources of SL-PRS region 913 includes sub-channel #1, sub-channel #2, sub-channel #3, sub-channel #4, sub-channel #5, sub-channel #6, sub-channel #7, and sub-channel #8; and the comb size is 6.

The configuration information may further indicate the indices of the AGC symbols, which include symbol #0 and symbol #6; the index of the Rx-Tx turnaround symbol, which include symbol #5 and symbol #13, and indicates indices of the bandwidth of this SL-PRS slot by the unit of sub-channel, which includes: sub-channel #0, sub-channel #1, sub-channel #2, sub-channel #3, sub-channel #4, sub-channel #5, sub-channel #6, sub-channel #7, sub-channel #8, and sub-channel #9.

In conclusion, the configuration information for the sidelink slot structure in FIG. 9 may include the following:

```
“SL-PRS slot structure configuration #2,
{
      SCI region 901, sub-channel index, symbol index, total number of SCI
transmission
  {
    sub-channel #0, sub-channel #3,
    symbol #1, symbol #2, symbol #3, symbol #4
    total number of SCI transmission = 2 (e.g., a total number of RBs for each SCI
    transmission = 1/2 of a total number of RBs of sub-channel #0 and sub-channel
    #3)
    }
  SL-PRS region 911, sub-channel index, symbol index, comb type
  {
    sub-channel #1, sub-channel #2,
    symbol #1, symbol #2, symbol #3, symbol #4
    comb size =2
  }
      SCI region 902, sub-channel index, symbol index, total number of SCI
transmission
  {
    sub-channel #4, sub-channel #5,
    symbol #1, symbol #2, symbol #3, symbol #4
    total number of SCI transmission = 4 (e.g., each SCI is transmitted on half of
    sub-channel) (i.e., a total number of RBs for one SCI transmission = 1/4 of a total
    number of RBs of sub-channel #4 and sub-channel #5)
    }
  SL-PRS region 912, sub-channel index, symbol index, comb type
  {
  sub-channel #6, sub-channel #7, sub-channel #8, sub-channel #9,
  symbol #1, symbol #2, symbol #3, symbol #4
  comb size =4
  }
      SCI region 903, sub-channel index, symbol index, total number of SCI
transmission
  {
    sub-channel #0, sub-channel #9,
    symbol #7, symbol #8, symbol #9, symbol #10, symbol #11, symbol #12
    total number of SCI transmission = 6 (e.g., each SCI is transmitted on 1/3
    sub-channel) (i.e., a total number of RBs for SCI transmission = 1/6 of a total
    number of RBs of sub-channel #0 and sub-channel #9)
    }
  SL-PRS region 913, sub-channel index, symbol index, comb type
  {
    sub-channel #1, sub-channel #2, sub-channel #3, sub-channel #4, sub-channel #5,
    sub-channel #6, sub-channel #7, sub-channel #8,
    symbol #7, symbol #8, symbol #9, symbol #10, symbol #11, symbol #12
    comb size = 6
  }
  AGC symbol(s) index
  {symbol #0, symbol #6}
  Rx-Tx turnaround symbol(s) index
  {symbol #5, symbol #13}
  The bandwidth of this SL-PRS slot by the unit of sub-channel,
  {
  sub-channel #0, sub-channel #1, sub-channel #2, sub-channel #3, sub-channel #4,
  sub-channel #5, sub-channel #6, sub-channel #7, sub-channel8#, sub-channel#9
  }
}”
```

In some embodiments, the comb size may be 12. FIG. 10 below shows such an embodiment.

FIG. 10 illustrates a sidelink slot structure according to some embodiments of the present disclosure.

There are 14 symbols in one time slot in time domain, which are marked by #0 to #13, respectively. There are 10 sub-channels in frequency domain, which are marked by sub-channel #0 to channel #9 respectively.

The set of indices of time domain resources of SCI region, 1001 in FIG. 10, includes symbol #1 to symbol #13; the set of indices of frequency domain resources of SCI region 1001 includes sub-channel #0 and sub-channel #9; and the total number of SCI transmissions in SCI region 1011 is 12. In the SCI region, each SCI transmission occupies ⅙ sub-channel. The set of indices of time domain resources of SL-PRS region, which is marked by 1011 in FIG. 10, includes symbol #1 to symbol #12; the set of indices of frequency domain resources of SL-PRS region 1011 includes sub-channel #2 to sub-channel #8; and the comb size is 12. Regarding one sub-channel including 12 RBs, the number of RBs for SCI transmission=2, RB #0 and RB #1 are the first ⅙ sub-channel of sub-channel #0, RB #2 and RB #3 are the second ⅙ sub-channel of sub-channel #0, . . . , and RB #10 and RB #11 are the last ⅙ sub-channel of sub-channel #0.

FIG. 11 illustrates a simplified block diagram of an exemplary apparatus of UCI transmission according to some embodiments of the present disclosure.

As shown in FIG. 11, an example of the apparatus 1100 may include at least one processor 1104 and at least one transceiver 1102 coupled to the processor 1104. The apparatus 1100 may be a UE, a LMF, a BS, a RAN node, a MN, an SN, or any other device with similar functions.

Although in this figure, elements such as the at least one transceiver 1102 and processor 1104 are described in the singular, the plural is contemplated unless a limitation to the singular is explicitly stated. In some embodiments of the present disclosure, the transceiver 1102 may be divided into two devices, such as a receiving circuitry and a transmitting circuitry. In some embodiments of the present disclosure, the apparatus 1100 may further include an input device, a memory, and/or other components.

In some embodiments of the present disclosure, the apparatus 1100 may be a UE. The transceiver 1102 and the processor 1104 may interact with each other so as to perform the operations of the UE described in any of FIGS. 1-10. In some embodiments of the present disclosure, the apparatus 1100 may be a network node. The transceiver 1102 and the processor 1104 may interact with each other so as to perform the operations of the network node described in any of FIGS. 1-10.

In some embodiments of the present disclosure, the apparatus 1100 may further include at least one non-transitory computer-readable medium.

For example, in some embodiments of the present disclosure, the non-transitory computer-readable medium may have stored thereon computer-executable instructions to cause the processor 1104 to implement the method with respect to the UE as described above. For example, the computer-executable instructions, when executed, cause the processor 1104 interacting with transceiver 1102 to perform the operations of the UE described in any of FIGS. 1-10.

In some embodiments of the present disclosure, the non-transitory computer-readable medium may have stored thereon computer-executable instructions to cause the processor 1104 to implement the method with respect to the node as described above. For example, the computer-executable instructions, when executed, cause the processor 1104 interacting with transceiver 1102 to perform the operations of the node described in any of FIGS. 1-10.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
obtain configuration information associated with a set of pairs of regions in time domain and frequency domain, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and
determine a sidelink slot structure based on the configuration information.

2. The UE of claim 1, wherein the at least one processor is configured to cause the UE to:
transmit a SCI transmission on the one or more resources within the first region; and
transmit the one or more SL-PRS sets on the one or more resources within the second region.

3. The UE of claim 1, wherein the at least one processor is configured to cause the UE to:
receive a SCI transmission on the one or more resources within the first region; and
receive the one or more SL-PRS sets on the one or more resources within the second region.

4. The UE of claim 1, wherein SCI includes, for a pair of regions within the set of pairs of regions, one or more of:
a set of indications of time domain resources of the one or more SL-PRS sets;
a set of indications of frequency domain resources of the one or more SL-PRS sets;
a set of comb sizes of the one or more SL-PRS sets; or
a set of resource element (RE) offset values of the one or more SL-PRS sets.

5. The UE of claim 1, wherein the configuration information includes, for the each pair of regions, one or more of:
an indication indicating a set of indices of time domain resources and a set of indices of frequency domain resources for the one or more resources within the first region;
a total number of resources for the set of SCI transmissions;
a size of resources for each SCI transmission;
a total number of SCI transmissions in the set of SCI transmissions;
an indication indicating a set of indices of time domain resources and a set of indices of frequency domain resources for the one or more resources within the second region;
a comb size of the one or more SL-PRS sets;
a set of indices of time domain resources of the one or more SL-PRS sets;
a set of indices of frequency domain resources of the one or more SL-PRS sets;
a set of comb sizes of the one or more SL-PRS sets;
a set of resource element (RE) offset values of the one or more SL-PRS sets;
or a bandwidth of the sidelink slot structure by a unit of subchannel or resource block (RB).

6. The UE of claim 5, wherein the set of indices of time domain resources includes one or more indices of symbols within the sidelink slot structure.

7. The UE of claim 5, wherein the set of indices of frequency domain resources includes one or more indices of sub-channels or one or more indices of resource blocks (RB)s within the sidelink slot structure.

8. The UE of claim 7, wherein the one or more indices of sub-channels or the one or more indices of RBs are continuous or discontinuous.

9. The UE of claim 1, wherein the one or more resources within the first region and the one or more resources within the second region are multiplexed in the frequency domain or in the time domain.

10. The UE of claim 1, wherein the configuration information further includes at least one of:
a set of indications for one or more symbols for automatic gain control (AGC) in the sidelink slot structure; or
a set of indications for one or more symbols for reception-transmission transition of the UE.

11. The UE of claim 1, wherein at least one of:
the configuration information is received from a location management function (LMF), a base station (BS), or another UE; or
the configuration information is pre-configured to the UE.

12. The UE of claim 1, wherein a first region of a first pair of regions of the set of pairs of regions and a first region of a second pair of regions of the set of pairs of regions are located in one of:
continuous one or more sub-channels;
discontinuous one or more sub-channels;
continuous one or more resource blocks (RBs); or
discontinuous one or more RBs.

13. A network node for wireless communication, comprising:
at least one memory; and
at least one processor coupled with the at least one memory and configured to cause the network node to:
determine configuration information associated with a set of pairs of regions in time domain and frequency domain, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and
transmit the configuration information.

14. The network node of claim 13, wherein the configuration information includes, for the each pair of regions, one or more of:
an indication indicating a set of indices of time domain resources and a set of indices of frequency domain resources for the one or more resources within the first region;
a total number of resources for the set of SCI transmissions;
a size of resources for each SCI transmission;
a total number of SCI transmissions in the set of SCI transmissions;
an indication indicating a set of indices of time domain resources and a set of indices of frequency domain resources for the one or more resources within the second region;
a comb size of the one or more SL-PRS sets;
a set of indices of time domain resources of the one or more SL-PRS sets;
a set of indices of frequency domain resources of the one or more SL-PRS sets;
a set of comb sizes of the one or more SL-PRS sets;
a set of resource element (RE) offset values of the one or more SL-PRS sets;
or a bandwidth of a sidelink slot structure by a unit of subchannel or resource block (RB).

15. A method performed by a user equipment (UE), the method comprising:
obtaining configuration information associated with a set of pairs of regions in time domain and frequency domain, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and
determining a sidelink slot structure based on the configuration information.

16. A processor for wireless communication, comprising:
at least one controller coupled with at least one memory and configured to cause the processor to:
obtain configuration information associated with a set of pairs of regions in time domain and frequency domain, wherein each pair of regions within the set of pairs of regions is associated with one or more resources within a first region and one or more resources within a second region, wherein the one or more resources within the first region are for a set of sidelink control information (SCI) transmissions, and wherein the one or more resources within the second region are for one or more sidelink positioning reference signal (SL-PRS) sets associated with the set of SCI transmissions; and
determine a sidelink slot structure based on the configuration information.

17. The processor of claim 16, wherein the at least one controller is configured to cause the processor to:
transmit a SCI transmission on the one or more resources within the first region; and
transmit the one or more SL-PRS sets on the one or more resources within the second region.

18. The processor of claim 16, wherein the at least one controller is configured to cause the processor to:
receive a SCI transmission on the one or more resources within the first region; and
receive the one or more SL-PRS sets on the one or more resources within the second region.

19. The processor of claim 16, wherein SCI includes, for a pair of regions within the set of pairs of regions, one or more of:
a set of indications of time domain resources of the one or more SL-PRS sets;
a set of indications of frequency domain resources of the one or more SL-PRS sets;
a set of comb sizes of the one or more SL-PRS sets; or
a set of resource element (RE) offset values of the one or more SL-PRS sets.

20. The processor of claim 16, wherein the configuration information includes, for the each pair of regions, one or more of:
an indication indicating a set of indices of time domain resources and a set of indices of frequency domain resources for the one or more resources within the first region;
a total number of resources for the set of SCI transmissions;
a size of resources for each SCI transmission;
a total number of SCI transmissions in the set of SCI transmissions;
an indication indicating a set of indices of time domain resources and a set of indices of frequency domain resources for the one or more resources within the second region;
a comb size of the one or more SL-PRS sets;
a set of indices of time domain resources of the one or more SL-PRS sets;
a set of indices of frequency domain resources of the one or more SL-PRS sets;
a set of comb sizes of the one or more SL-PRS sets;
a set of resource element (RE) offset values of the one or more SL-PRS sets; or
a bandwidth of the sidelink slot structure by a unit of subchannel or resource block (RB).
